(19) United States
(12) Patent Application Publication
(10) Pub. No.: US 2002/0046812 A1
(43) Pub. Date: Apr. 25, 2002

(54) End-to-end connection device for a continuous unrolling machine

(75) Inventors: Bernard Muller, Drusenheim (FR); Jean-Louis Dumas, Guebwiller (FR)

Correspondence Address: YOUNG & THOMPSON, 745 SOUTH 23RD STREET 2ND FLOOR, ARLINGTON, VA, 22202

(73) Assignee: MONOMATIC

(21) Appl. No.: 09/978,799

(22) Filed: Oct. 18, 2001

(30) Foreign Application Priority Data
Oct. 19, 2000 (FR) 00 13394

(51) Int. Cl. G03D 15/04

(52) U.S. Cl. 156/507; 156/519

(57) ABSTRACT

The present invention relates to a device for end to end connecting for a machine for continuously unrolling, with end to end connection between two strips, an ending strip (1) and a new strip (2), comprising at least means (3) for unrolling two spools, an accumulator for the strip (4) and a device for connecting and cutting.

The device is characterized in that it is essentially constituted by an end to end cutting and connecting station (5) for the strips (1 and 2) comprising two opposed pivoting assemblies (6) for preparation, cutting and connecting the ending strip (1) and the new strip (2) each provided with a temporary guiding and holding means (7) for said strips (1 and 2).

The invention is more particularly applicable in the field of continuous unrolling machines for material in strips, in particular spools of PVC or labels or other materials of relatively low flexibility, to continuously supply printing, production or other machines.

The present invention relates to the field of machines for continuously unrolling strip material, in particular spools of PVC or labels or other materials of relatively low flexibility, to supply continuously machines for printing, production or the like, and has for its object a device for connecting end to end so that such a machine can unroll continuously.

The end to end connection between ending strips of material and beginning ones, in particular material of relatively low flexibility, is generally carried out by the use of two adhesive strips simultaneously glued on opposite sides of the joint between the strips at the abutting ends. This connection must resist the traction exerted on the strip during unrolling, as well as during further operations of production or the like.

To carry out such an end to end connection, different cutting and connecting devices have been proposed, particularly by WO 98/02 372 and by GB 2 148 856, permitting cutting the end and new material strips, followed by an end to end connection with the application of an adhesive strip on each side of the joint between the strips. The connection thus obtained is generally reliable.

However, these known devices, which are provided with a supply means for adhesive strips upstream of the joint, have the drawback of requiring a large size for their cutting and connecting station, so as to permit the emplacement of the adhesive strips on the applicators. Moreover, the adhesive strips used being generally of high adhesive power, they have the tendency to twist and thus to prevent abutment and correct connection, which can result in jamming the machine at the cutting and connection station and/or an interruption of the continuous unrolling.

The present invention has for its object to overcome these drawbacks by providing an end to end connecting device for a machine for continuously unrolling, permitting end to end connection between two strips, beginning and ending, guaranteeing a perfect junction between said strips and avoiding any risk of incident during connection.

To this end, the end to end connecting device for a continuously unrolling machine, comprising at least one unrolling means for two spools, a strip accumulator and a connection and cutting device, is characterized in that it is essentially constituted by a cutting and connecting station for end to end strips, comprising two pivoting opposed assemblies for preparation, cutting and connecting the beginning and ending strips, each provided with a guiding and temporary holding means for said strips.

The invention will be better understood from the following description, which relates to a preferred embodiment, given by way of non-limiting example and explained with reference to the accompanying schematic drawings, in which:

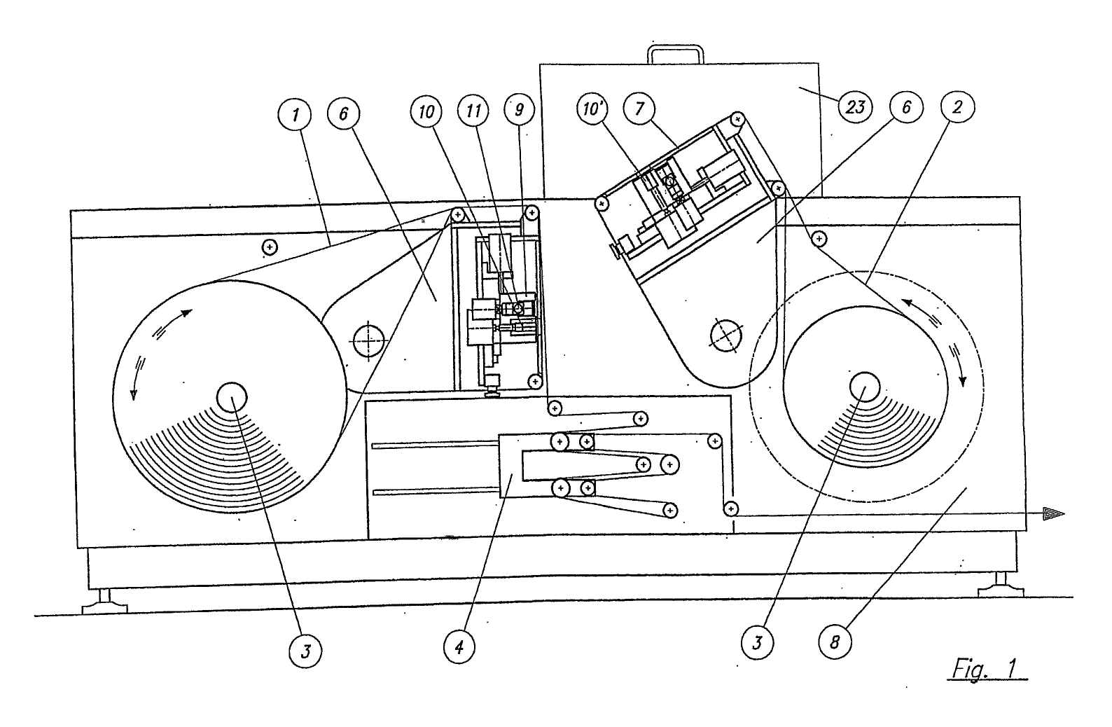

FIG. 1 is a side elevational view of an unrolling machine provided with an end to end connecting device according to the invention;

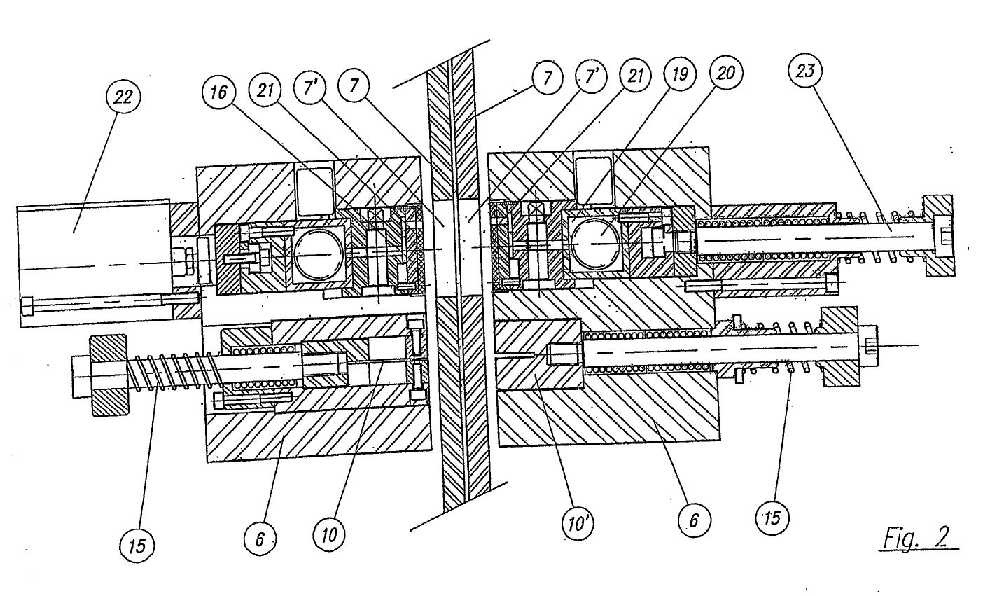

FIG. 2 is a fragmentary side elevational and cross-sectional view, on a larger scale, showing the detail of the cutting device and the means for applying adhesive strips at the end to end cutting and connecting station, and

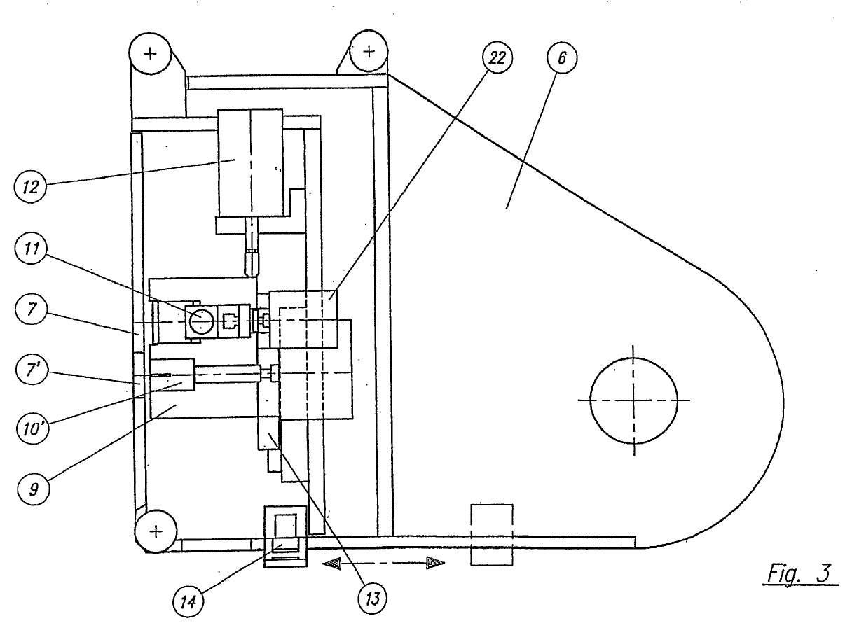

FIG. 3 is a schematic side elevational view of one of the pivoting assemblies for preparation, cutting and connecting the beginning and ending strips.

FIG. 1 of the accompanying drawings shows a continuous unrolling machine permitting continuous unrolling with end to end connection between two strips, an ending strip 1 and a new strip 2, and comprising at least an unrolling means 3 for two spools, a strip accumulator 4 and a connecting and cutting device.

According to the invention, the connecting and cutting device is essentially constituted by a cutting and connecting station 5, for the strips 1 and 2 end to end, comprising two opposed pivoting assemblies 6 for preparation, cutting and connecting the ending strip 1 and the new strip 2 each provided with guiding and temporary holding means 7 for said strips.

The unrolling machine according to the invention is essentially adapted for unrolling strips of relatively rigid material such as PVC, or forming a label support, so as to obtain perfectly reliable end to end connection, which is to say guaranteeing the resistance to separation by tearing apart of the strip at the junction with the adhesive strips.

To this end, it is a matter of obtaining a perfect abutment between the beginning strip and the ending strip and an optimum application of the adhesive strips on the corresponding ends of said strips at the joint, whilst avoiding twisting or curling of the ends of the strips to be connected and said adhesive bands, before connection or in the course of connection.

This objective is achieved by the use of the cutting and connection station 5 for the end to end connection of the strips 1 and 2.

According to one characteristic of the invention, the two opposite pivoting assemblies 6 for preparation, cutting and connection of the ending strip 1 and the new strip 2, each provided with a temporary guiding and holding means 7 for said strips, are complementary and each consists of a pivoting chassis mounted on a support shaft of the frame 8 of the machine and comprising, at their end opposite the support shaft, the means 7 for temporarily guiding and holding the strips, a casing 9, that can slide parallel to said temporary guide and holding means 7 and in the direction of movement of the strips 1 and 2, being guided in said pivoting chassis 6 and carrying, on the one hand, a portion 10 or 10′ of a cutting device and, on the other hand, a means 11 for receiving and applying an adhesive strip.

Each pivoting frame constituting one of the opposed pivoting assemblies for preparation, cutting and connecting the ending strip 1 and the new strip 2 is preferably connected to a pivoting means actuated by a jack (not shown) and is provided, on the one hand, with an actuator 12 for moving the casing 9 parallel to the temporary guiding and holding means 7, in the form of a jack or the like and, on the other hand, with means 13 for sliding guidance of the casing 9, such as rails or bars (FIG. 3).

Moreover, each pivoting frame 6 is provided with a device 14 for gripping the beginning of a new strip 2, this device 14 being present preferably in the form of a movable cross piece mounted on one of the surfaces of said pivoting frame adjacent to that forming the temporary guidance and holding means 7. This movable cross piece is guided relative to the corresponding surface by means of guides (not shown) mounted laterally and perpendicularly to this surface and is actuated for gripping movement against the surface by means of a jack (not shown), the return into spaced position from said surface being ensured by return springs (not shown) mounted on said guides.

Thus, the new strip 2 can be perfectly held on the pivoting frame 6 for further operations of cutting and connection end to end with the ending strip 1.

The cutting device is constituted by two portions 10 and 10 ′ consisting respectively of a blade 10 and a counterblade 10′ mounted one in one of the casings 9 and the other in the other casing 9 in a perfectly symmetrical way (FIG. 2). The blade 10 and the counterblade 10′ are each actuated in a direction to move toward each other, by means of a jack (not shown) mounted on the corresponding casing and are moreover loaded each by a member 15 to return to the rest position, for example in the form of an extraction rod loaded by a return spring.

The means 11 for receiving and applying an adhesive strip is preferably in the form of a slide guided slidably in the casing 9, transversely to the direction of movement of the strips 1 and 2 and provided on one external surface with a suction channel 16 connected to a chamber 19, which is itself in communication with a suction conduit 20 guided in sealed manner in one of the ends of the slide, on the side opposite that of extraction of the casing 9 and connected to a central suction means (not shown). This latter means can be in the form of a suction pump connected to the conduit 20 by a flexible connection.

Near its free end entering the chamber 19 of the slide forming the means 11, the suction conduit 20 is provided with a stop ring preventing any total extraction of said conduit 20 out of the chamber 19. The slide 20 can thus be withdrawn, from one side, from the casing 9 for the emplacement on the external surface of an adhesive strip 21, whilst avoiding untimely dismounting of said slide. Moreover, this embodiment permits intermediate holding of the adhesive strip 21 because of the suction created on the external surface of the slide, this in the position of the slide outside the casing 9.

According to another characteristic of the invention, the means 11 formed by the slides are displaceable in the direction of the strips 1 and 2, in the surface position of the pivoting frames 6, each by means of a jack 22 and are returned to the rest position (shown in FIG. 2) by means of a return member 23 to the rest position, for example in the form of an extraction rod loaded by a return spring.

Each temporary guiding and holding means 7 of the strips 1 and 2 is constituted by a rigid plate comprising at least one opening 7′ for the passage of the portions 10, 10′ of the cutting device or of the means 11 and of a cross-section slightly greater than that of said device and means. The portions 10, 10′ of the cutting device and the means 11 for receiving and applying an adhesive strip 21 can, when moved before the openings 7′ of the means 7, coact respectively for cutting the strips 1 and 2 and for connecting the strips end to end.

The plates forming the means 7 are preferably provided, on opposite sides of the openings 7′ and over all the length of guiding the strips 1 and 2, with suction grooves (not shown) connected to two suction chambers (not shown), each chamber being itself connected individually to a central suction means. The provision of such suction grooves permits effective placement of the strips 1 and 2 against the means 7 and holds the coupled portions of said strips after cutting. It thus will suffice, after releasing the vacuum in the chamber in question, namely the one relative to the end of the new strip and that relative to the portion of the ending strip from the spool, to withdraw the ends of the finished strip 1 and new strip 2 in question, from between the means 7 so as no longer to have more than two ends of the abutting strips to connect.

A consecutive movement of the casings 9 bringing the means 11 with the adhesive strips 21 in front of the openings 7′, will thus permit the triggering of the connection operation properly so-called, which is carried out by actuating corresponding jacks 22. It follows that the adhesive strips 21 are applied on opposite sides of the joint, on the ends of the strips 1 and 2. At the end of actuation of the jacks 22, the means 11 are automatically returned to their starting position and the new strip 2 can be driven toward a downstream machine.

Thus, it is possible, by simultaneous movement of the casings 9, to bring successively the blade 10 and the counterblade 10′ of the cutting device, then the means 11 for receiving and applying an adhesive strip 21, in front of the openings 7′ of the temporary guide and holding means 7 of the strips 1 and 2 and then, after intimate application of said elements against the strips 1 and 2 in the direction of gripping the latter, to carry out simultaneous cutting of said strips 1 and 2 and after this cutting to effect end to end connection.

The unused portions of the strips, namely the end of the new strip 2 gripped in the gripping device 14, as well as the end of the ending strip 1 from the ending spool, can be removed respectively manually by traction on this end of the strip after releasing the corresponding vacuum in the means 7 and after opening the gripping device 14 and by actuation of the ending spool in the direction of winding up this latter.

The suction means for holding the adhesive strips 21 as well as the strips 1 and 2 against the internal surfaces of the means 7, are of known type and do not require more detailed description. Preferably, the suction grooves can be disposed symmetrically group-wise relative to the longitudinal axis of the strips 1 and 2 and be connected to negative pressure chambers controlled pairwise. In a known manner, each negative pressure chamber can be connected to a central suction means by means of manual control valves. Such an arrangement is also known to those skilled in the art and similarly requires no more detailed description.

The two opposite pivoting assemblies 6 for preparation, cutting and connecting the ending strip 1 and the new strip 2, each provided with temporary guiding and holding means 7 for said strips, are preferably disposed in a closed frame 8 provided with a front portion closed by sliding or swinging doors (not shown in detail) the upper portion of the machine, above the assemblies 6 being provided with covers 23 that can be lowered.

The front doors permit access, particularly to the spools to be unrolled and to the strip accumulator 4, whilst the lowerable covers 23 permit, after opening, a pivoting of the assemblies 6 into a preparatory position for a new strip 2, as shown in FIG. 1 of the accompanying drawings.

The preferred embodiment shown in FIG. 1 provides a construction in which the unrolling machine is present in the form of a relatively low machine in which the spools are disposed at a same horizontal level and the cutting and connection takes place in a vertical position at the strips. However, it can easily be envisaged that the cutting of the strips takes place in a horizontal position and that the spools be disposed vertically one above the other with interposition of the cutting and connection device.

Thanks to the invention, it is possible to provide an unrolling machine permitting unrolling two spools and their end to end connection, whilst avoiding malfunction generated by the curve of the strips or by the adhesive strips generally leading to the production of a curling effect.

Moreover, the obtained connection is particularly reliable.

Of course, the invention is not limited to the embodiment described and shown in the accompanying drawings. Modifications remain possible, particularly as to the construction of the various elements or by substitution of technical equivalents, without thereby departing from the scope of protection of the invention.

1. End to end connection device for a continuous unrolling machine, with end to end connection between two strips, an ending strip (1) and a beginning strip (2), comprising at least means (3) for unrolling two spools, a strip accumulator (4) and a device for connecting and cutting, characterized in that it is essentially constituted by an end to end cutting and connection station (5) for the strips (1 and 2) comprising two opposed pivoting assemblies (6) for preparation, cutting and connecting the ending strip (1) and the beginning strip (2) each provided with a temporary guiding and holding means (7) for said strips (1 and 2).

2. Device according to claim 1, characterized in that the two pivoting opposed assemblies (6) for preparation, cutting and connecting the ending strip (1) and the beginning strip (2) each provided with a temporary guiding and holding means (7) for said strips, are complementary and each consist in a pivoting chassis mounted on a support shaft of the frame (8) of the machine and comprising, at their end opposite said support shaft, the temporary guiding and holding means (7) for the strips, a casing (9), that can slide parallel to said temporary guiding and holding means (7) and in the direction of movement of the strips (1 and 2), being guided in said pivoting chassis (6) and carrying, on the one hand, a portion (10 or 10′) of a cutting device and, on the other hand, a means (11) for receiving and applying an adhesive strip.

3. Device according to any one of claims 1 and 2, characterized in that each pivoting chassis constituting one of the pivoting opposed assemblies (6) for preparation, cutting and connecting the ending strip (1) and the new strip (2) is connected to a pivoting means actuated by a jack and is provided, on the one hand, with an actuator (12) for movement of the casing (9) parallel to the temporary guiding and holding means (7), in the form of a jack or the like and, on the other hand, with means (13) for slidably guiding the casing (9), such as rails or bars.

4. Device according to any one of claims 1 to 3, characterized in that each pivoting chassis (6) is provided with a gripping device (14) for the end of a new strip (2), this device (14) being in the form of a movable crosspiece mounted on one of the surfaces of said pivoting chassis adjacent that forming the temporary guiding and holding means (7).

5. Device according to claim 4, characterized in that the movable crosspiece forming the gripping device (14) is guided for movement relative to the corresponding surface by means of guides mounted laterally and perpendicularly to said surface and is actuated in its gripping movement against the surface by means of a jack, the return to the position spaced from said surface being ensured by return springs mounted on said guides.

6. Device according to claim 2, characterized in that the cutting device is constituted by two portions (10 and 10′) consisting respectively of a blade (10) and a counterblade (10′) mounted, one in one of the casings (9) and the other in the other casing (9) in a perfectly symmetrical manner.

7. Device according to claim 6, characterized in that the blade (10) and the counterblade (10′) are each actuated in a mutually approaching direction by means of a jack, mounted on the corresponding casing and are moreover loaded each by a return member (15) in the rest position, for example in the form of an extraction rod loaded by a return spring.

8. Device according to claim 2, characterized in that the means (11) for receiving and applying an adhesive strip are present in the form of a slide guided slidably in the casing (9), transversely to the direction of movement of the strips (1 and 2) and provided with an external surface having suction channels (16) connected to a chamber (19), which is itself in communication with a suction conduit (20) guided in a sealed manner in one of the ends of the slide, on the side opposite that for extraction of the casing (9) and connected to a central suction means.

9. Device according to claim 8, characterized in that near its free end entering into the chamber (19) of the slide forming the means (11), the suction conduit (20) is provided with a stop ring preventing any total removal of said conduit (20) from the chamber (19).

10. Device according to any one of claims 8 and 9, characterized in that the means (11) formed by the slides are movable in the direction of the strips (1 and 2), in the service position of the pivoting chassis (6), each by means of a jack (22) and are returned to the rest position by means of a return member (23) in the rest position, for example in the form of an extraction rod loaded by a return spring.

11. Device according to any one of claims 1 and 2, characterized in that each temporary guiding and holding means (7) for the strips (1 and 2) is constituted by a rigid plate comprising at least one opening (7′) for passage of the portions (10, 10′) of the cutting device or of the means (11) and of a cross-section slightly greater than that of said device and means.

12. Device according to any one of claims 1, 2 and 11, characterized in that the plates forming the means (7) are provided, on opposite sides of the openings (7′) and over all the width for guiding the strips (1 and 2) with suction grooves connected to two suction chambers, each chamber being itself connected individually to a central suction means.

13. Device according to any one of claims 1 to 12, characterized in that the two opposed pivoting assemblies (6) for preparing, cutting and connecting the ending strip (1) and the beginning strip (2), each provided with a temporary guiding and holding means (7) for said strips, are disposed in a closed frame (8) and provided on a frontal portion closed by sliding or swinging doors, the upper portion of the machine, above the assemblies (6) being provided with lowerable covers (23).
